(19) United States
(12) Patent Application Publication
(10) Pub. No.: US 2025/0292341 A1
(43) Pub. Date: Sep. 18, 2025

(54) Automated Title Transfer System

(71) Applicant: Titl, Inc., Lewes, DE (US)

(72) Inventors: Ori Ohayon, Bay Harbour Island, FL (US); Tory Ricalis, Keswick (CA)

(73) Assignee: Titl, Inc., Lewes, DE (US)

(21) Appl. No.: 19/223,176

(22) Filed: May 30, 2025

Related U.S. Application Data
(63) Continuation of application No. 18/620,538, filed on Mar. 28, 2024.
(60) Provisional application No. 63/455,500, filed on Mar. 29, 2023.

(51) Int. Cl. G06Q 50/16; G06Q 30/0601

(52) U.S. Cl. CPC G06Q 50/16; G06Q 30/0637; G06Q 30/0641

(57) ABSTRACT

A property interactive system includes the seller to display seller added listings. The property interactive system further includes a review property module. The property interactive system further includes a buyer the ability for immediate purchase of a listing using an on-chain title, the seller inspects pending buyer offers through to either accept the pending offer or deny the pending offer.

### CROSS-REFERENCE TO RELATED APPLICATIONS

This application is a continuation-in-part of U.S. application Ser. No. 18/620,538 filed Mar. 28, 2024 which claims priority under 35 U.S.C. § 119 to U.S. Provisional Application No. 63/455,500, filed Mar. 29, 2023.

### FIELD OF THE INVENTION

The present invention pertains to real estate and, more particularly, to an improved system of property title verification monitoring and transfer process for real estate.

### BACKGROUND

The invention of the property interactive system provides a solution for enhancing the efficiency of property transactions for real estate brokers, lenders, title agents, title lawyers, buyers, and sellers. This solution includes an API-based tool that seamlessly integrates with existing brokerage platforms, transforming an address and/or a real estate listings data into a set of blockchain protected smart contracts. The property interactive system sources and verifies the authenticity of the data against the relevant land registry and public records, storing the property title report on the distributed ledger as an asset via smart contract. This streamlined process significantly reduces the time and cost associated with title verification, monitoring and transfers for real-world properties.

Utilizing distributed ledger technology, the property interactive system provides a universal and immutable database for securing and protecting property ownership documents and title reports. Digitizing property titles enables faster title transfers, reduces transaction costs, and eliminates paper waste and inefficiencies, making property ownership accessible to more individuals. Furthermore, the transparency of the database enhances the protection of user data, eliminating the risk of title fraud.

### SUMMARY

A property interactive system includes a selectable property by a front-end user within a front-end user functionality triggering a plurality of back-end user functionalities; the plurality of back-end user functionalities utilizes large language models to generate a autonomous title report module and a title monitoring module; the back-end user functionality will access a various public repositories including county clerks, public records, utilities, and property appraiser databases performing an A.I. data scraping of various documents in order to present chain of title, tax records, code enforcement, permit status, judgements, liens, notice of commencements, lis pendense, mortgages, etc. All the data necessary to conduct a title transfer. Which is sourced and indexed by a chain of title through an index folio number and index property information; the back-end user functionalities will access appropriate municipal, and county records and determine what data is relevant to the selectable property and perform A.I. data scraping of all public documentation affiliated with the requested property to generate the chain of title and formulate the automated rapid report, and send the generated rapid report to the front-end user, the back-end user functionality will repeat the process in a repeated daily timeframe.

### BRIEF DESCRIPTION OF DRAWINGS

In the following, the present invention is described in more detail with references to the drawings in which:

FIG. 1 illustrate a schematic diagram of hardware infrastructure for the property interactive system;

FIG. 2A illustrates another isolated schematic diagram of a portion of a global flow chart of the implementation of the system;

FIG. 2B illustrates another isolated schematic diagram of a portion of a global flow chart of the implementation of the system;

FIG. 2C illustrates another isolated schematic diagram of a portion of a global flow chart of the implementation of the system;

FIG. 3 illustrates another isolated schematic diagram of a portion of a global flow chart of the implementation of the system;

FIG. 4 illustrates another isolated schematic diagram of a portion of a global flow chart of the implementation of the system;

FIG. 5A illustrates another isolated schematic diagram of a portion of a global flow chart of the implementation of the system;

FIG. 5B illustrates another isolated schematic diagram of a portion of a global flow chart of the implementation of the system;

FIG. 5C illustrates another isolated schematic diagram of a portion of a global flow chart of the implementation of the system;

FIGS. 6a and 6b illustrate a transaction schematic diagram of the system;

FIG. 7 illustrates an isolated schematic diagram of a portion of a global flow chart of the implementation of the system;

FIG. 8 illustrates a snapshot of the system;

FIG. 9 illustrates another perspective view of the system;

FIG. 10 illustrates another perspective view of the system;

FIG. 11 illustrates another perspective view of the system;

FIG. 12 illustrates another perspective view of the system;

FIG. 13A illustrates another perspective view of the system;

FIG. 13B illustrates another perspective view of the system;

FIG. 14 illustrates another perspective view of the system;

FIG. 15 illustrates another perspective view of the system;

FIG. 16 illustrates another perspective view of the system; and

FIG. 17 illustrates a diagram of the interaction of the block chain aspect of the invention.

### DETAILED DESCRIPTION OF THE EMBODIMENTS

With reference to the Figures, a property interactive system 1 according to the invention is shown.

In the exemplary embodiment, the property interactive system 1 generally includes an application site. One of ordinary skill in the art would understand the applicant's design is not the exclusive embodiment. In the exemplary embodiment, the application site is designed to work on internet Explorer 10+, and the most up-to-date versions of Chrome, Safari and Firefox across all major operating systems and updated device platforms for example Android and IOS. One of ordinary skill in the art would understand the applicant's design is not the exclusive embodiment.

Hardware infrastructure for an embodiment of the property interactive system 1 will be described. In an exemplary embodiment, the property interactive system 1 is built on a network router (for instance, a wireless router) and connected to a database server, while also utilizing known hardware components, including a web server, a firewall, a network, and the computing device.

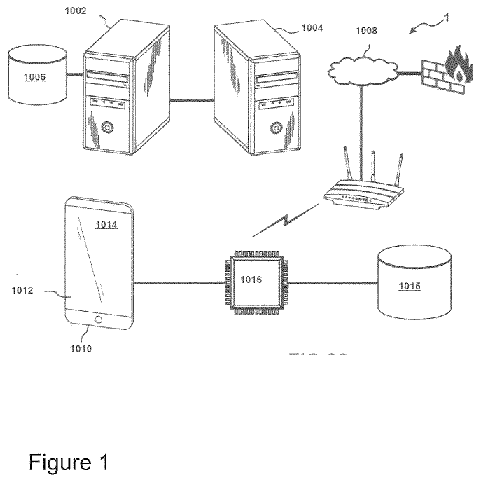

Referring first to FIG. 1, which is a broad overview of the hardware infrastructure for an embodiment of the property interactive system 1 will be described. To perform the aforementioned and other functions, the property interactive system 1 generally includes a plurality of integrated system servers 1002, 1004 with one or more databases 1006 (i.e., internal information repository), a network interface 1008 accessible through various known communication protocols, such as TCP/IP, cellular protocols including GSM, Wi-Fi, Wi-Max, or other wireless communications technologies or combination of wired or wireless channels, network security devices (where necessary), and a computing device 1010 having a processing unit 1016 and memory 1015.

The property interactive system 1 allows a user to access a plurality of system files that includes data, such as information and images, through the computing device 1010 and a network traffic information on the database server 1002 (i.e. SQLServer or PostgreSQL (also known as Postgres) or newer) that connects to a web server 1004. The web server 1004 functions as a way for network interface 1008 to communicate to the database server 1002 through known application-programming interface (API) between the computing device 1010 and the database server 1002. A firewall may be used for security purposes such as, but is not limited to, blocking unauthorized access to the web server 1004 and permitting unauthorized communication thereto. The property interactive system 1 is designed to run through the computing device 1010 through a property interactive module that can be downloaded over personal area networks (PANs), local area networks (LANs), campus area networks (CANs), wide area networks (WANs), metropolitan area networks (MANs) and any new networking system developed in the future. One skilled in the art should appreciate that the property interactive system 1 can be maintained solely through the computing device 1010, as the property interactive system modules can be pre-loaded to the computing device 1010.

The computing device 1010 as depicted having a processor 1016 for performing the necessary calculations and performing the actions for the property interactive system module having a plurality of service modules within the property builder module, and also having memory 1015, configured for storing and accessing the property interactive system files, including a plurality of buyer user functions, a plurality of seller user functions, a plurality of attorney functions which may be employed in the property interactive simulation. In the shown embodiment, the user may connect to the network interface 1008 using the computing device 1010 through the router for instance. One skilled in the art would appreciate that other hardware and protocol designs are possible as long as such modifications would not divert from the spirit of the invention.

In an exemplary embodiment, as shown in FIG. 1, the computing device 1010 generally includes the graphical user interface 1014, the memory device 1015, and the processor 1016. In the shown embodiment, the computing device is a tablet computer or mobile phone with a touchscreen display 1012. The touchscreen display 1012 uses finger or stylus gestures to navigate the graphical user interface (GUI) 1014. However, one skilled in the art should appreciate that other implements could be used; including a computer mouse, a keyboard, or joystick. In fact, one skilled in the art should appreciate that the computing device 1010 is a physical computer and could be, but not limited to, a desktop computer, a laptop computer, or a cell phone, and utilize a downloaded application or web browser. The memory device 1015 is a storage device having computer components and recording media used to retain digital data. The processor 1016 is a central processing unit (CPU) that manipulates data stored in the memory device 1015 by performing computations.

In the exemplary embodiment, the property interactive system files, including the seller user functions, the buyer user functions, the approved agent functions and the developer user functions, and programming language necessary for performing the simulation may be loaded into the memory device 1015 of the computing device 1010, and performable by the processor 1016, utilizing user inputs through the graphical user interface 1014. In such an embodiment, there may be no need for communication through the network interface 1008 to communicate with external devices (e.g. servers 2, 4) through a network router.

In another exemplary embodiment, the property interactive system 1 includes and begins within the NestJS application, which instructs a web scraper to navigate to specified public database websites. A Bull Queue manages and sequences jobs for retrieving information from multiple public databases. A web scraper simulates browser actions to search for, retrieve, and download the required information and PDF documents. Once the PDF documents are downloaded, the NestJS application uploads these documents to a cloud storage bucket. Concurrently with PDF storage, the information retrieved by a web scraper (excluding the content of PDFs) is formatted and stored in a database. For PDF documents requiring text extraction, Cloud-based optical character recognition provider is triggered by AWS Lambda to analyze the documents for text and data, extracting information from forms and tables within the PDFs. With all data gathered and processed—both the directly retrieved information stored in the database and the text extracted from PDFs by the cloud-based optical character recognition provider—the NestJS application proceeds to compile this information into a comprehensive report. The whole service is protected by authentication with JWT. When a request is made (either by a user or an administrator), the NestJS application validates the JWT provided with the request.

In the exemplary embodiment, the NestJS serves as the core back-end framework for the property interactive system 1. The NestJS is a progressive Node.js framework for building efficient, reliable, scalable server-side applications. The NestJS orchestrates the overall process flow, from initiating web scraping with a web scraper to handle the database interactions and integrating with AWS services for PDF storage and processing.

The NestJS application communicates with the web scraper for data retrieval, interfaces with the database for data storage, and interacts with cloud based service providers for document storage and optical character recognition.

In the exemplary embodiment, the web scraper automates browser actions for scraping information and downloading PDF documents from public databases. The web scraper is operated by functions initiated from the NestJS application. Additionally, the web scraper interacts with web pages, extracts data, and downloads PDFs.

In the exemplary embodiment, the database (Postgre) stores retrieved information for persistent access and manipulation. Moreover, the database receives and stores data from the NestJS application, retrieved and processed through the web scraper. Additionally, the database receives and stores data from cloud-based optical character recognition provider. All properties added by a user in the system are stored in the PostgreSQL database. If a property is being monitored, it is indicated via the status column in the Property table in the database. All properties with the status of “MONITORING” in the database rerun the report generation job every 24 hours.

In the exemplary embodiment, the cloud storage bucket stores PDF documents retrieved from public databases. Additionally, the cloud storage bucket receives PDF files from AWS Lambda for storage and makes these files accessible for further processing by the cloud-based optical character recognition provider.

In the exemplary embodiment, the AWS Lambda manages the automated file processing of PDF documents from the cloud storage bucket to cloud-based optical character recognition provider. The AWS Lambda is triggered by the cloud storage bucket events and to initiate the cloud-based optical character recognition provider processing.

In the exemplary embodiment, the report compilation integrates and formats the collected information into a coherent report while utilizing data from the database, including text extracted by the cloud-based Optical Character Recognition Provider. The text extracted by the cloud-based Optical Character Recognition Provider is served as input to a Large Language Model in order to retrieve structured data that is used to generate reports.

In the exemplary embodiment, the report compilation integrates and formats the collected information into a coherent report while utilizing data from the database, including text extracted by cloud-based optical character recognition provider, to generate reports 8.

In the exemplary embodiment, the Bull Queue schedules and executes background jobs. The Bull Queue further manages dependencies between tasks, ensuring that jobs are executed in the correct sequence. Moreover, the Bull Queue manages and sequences jobs for retrieving information from multiple public databases.

In the exemplary embodiment, the JWTs serve as a secure way to authenticate users. When a request is made (either by a user or an administrator), the NestJS application validates the JWT provided with the request. Essentially, the JWTs identifies if a user has permission to access the property interactive system 1.

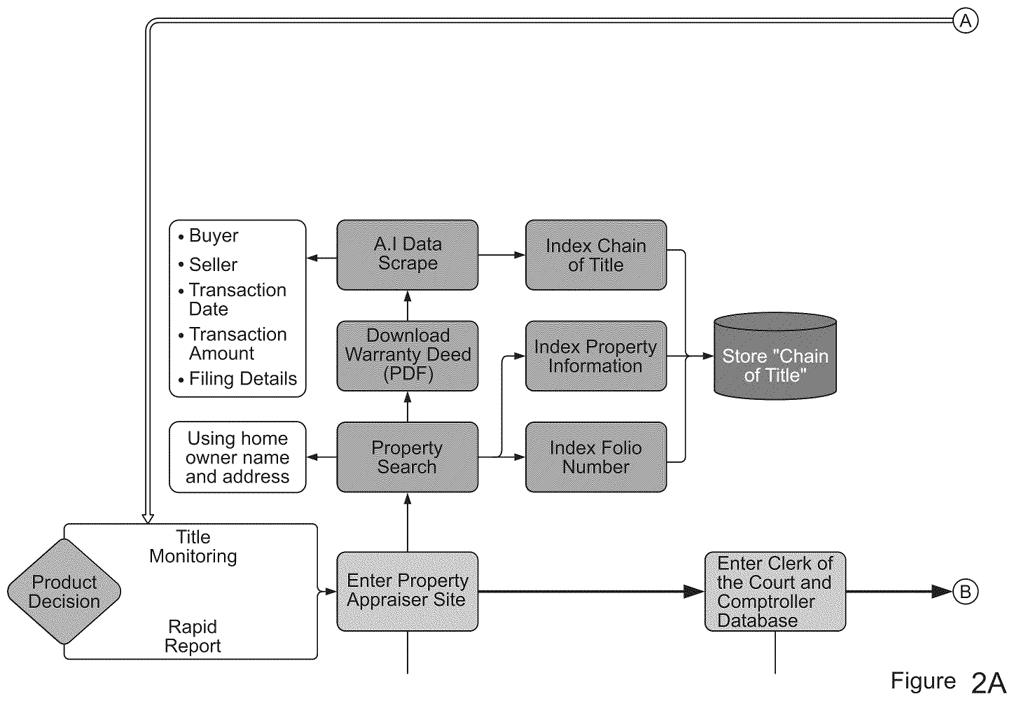

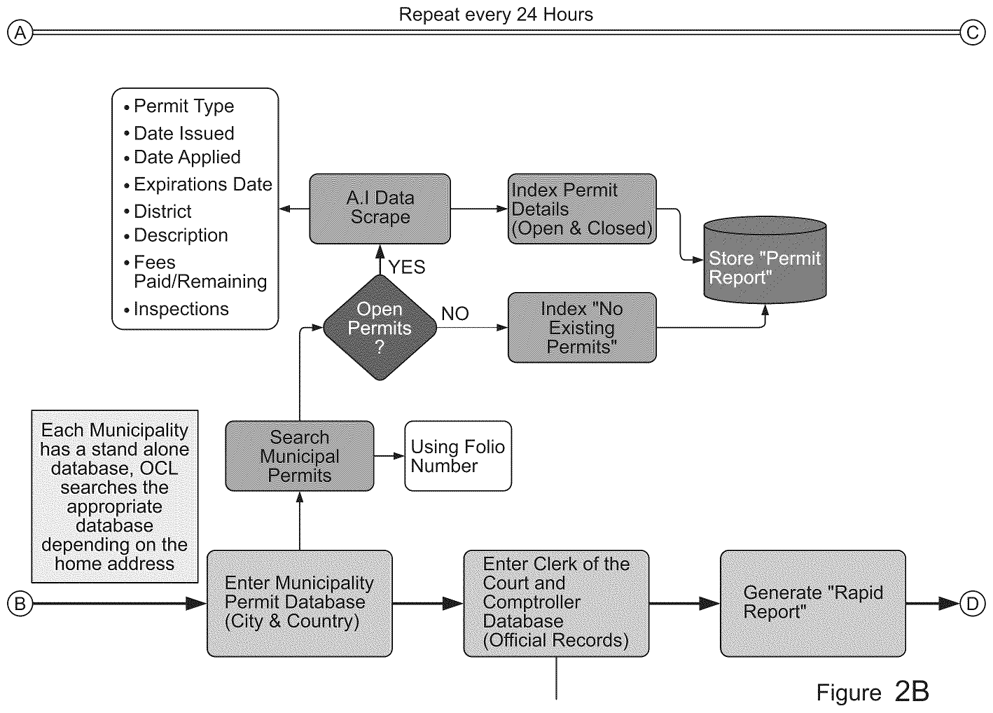

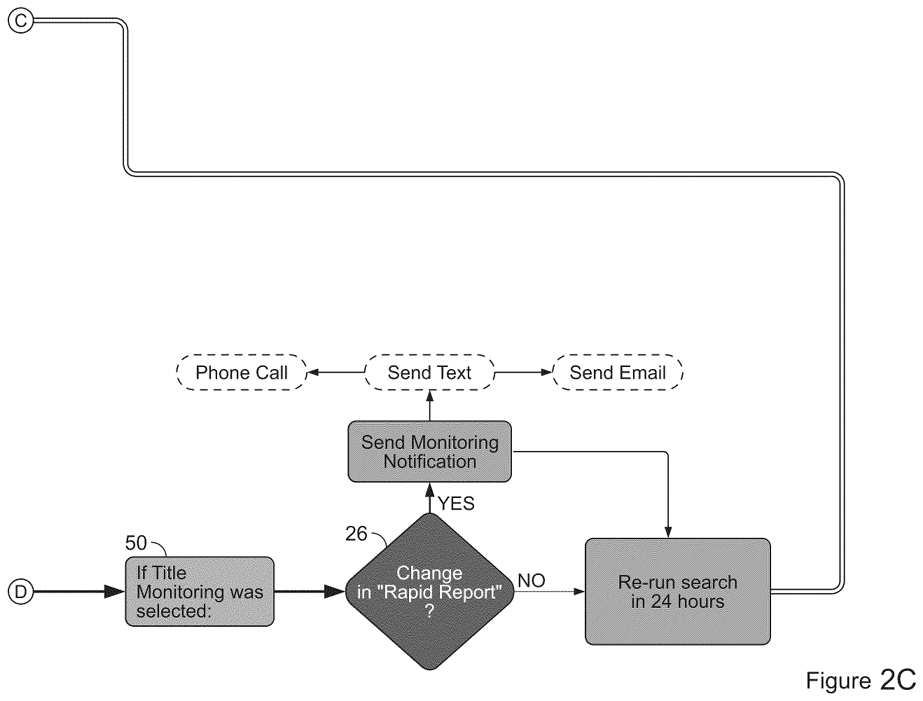

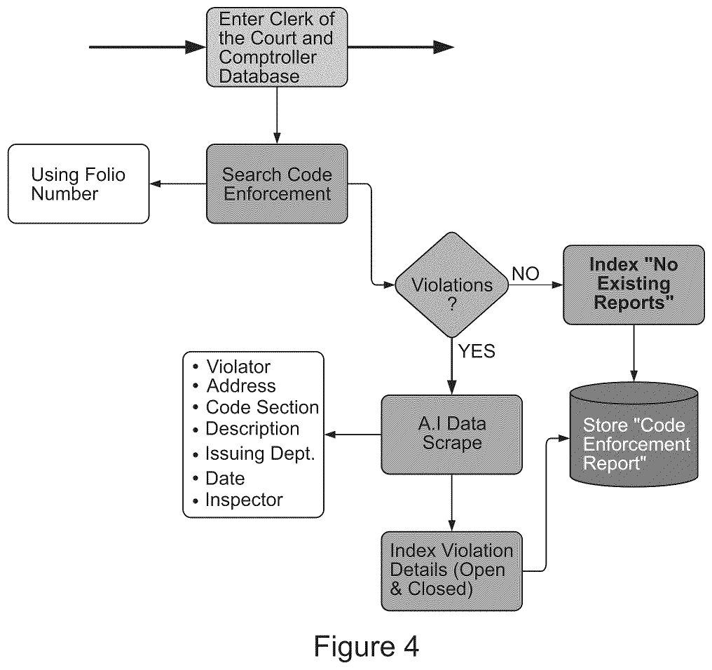

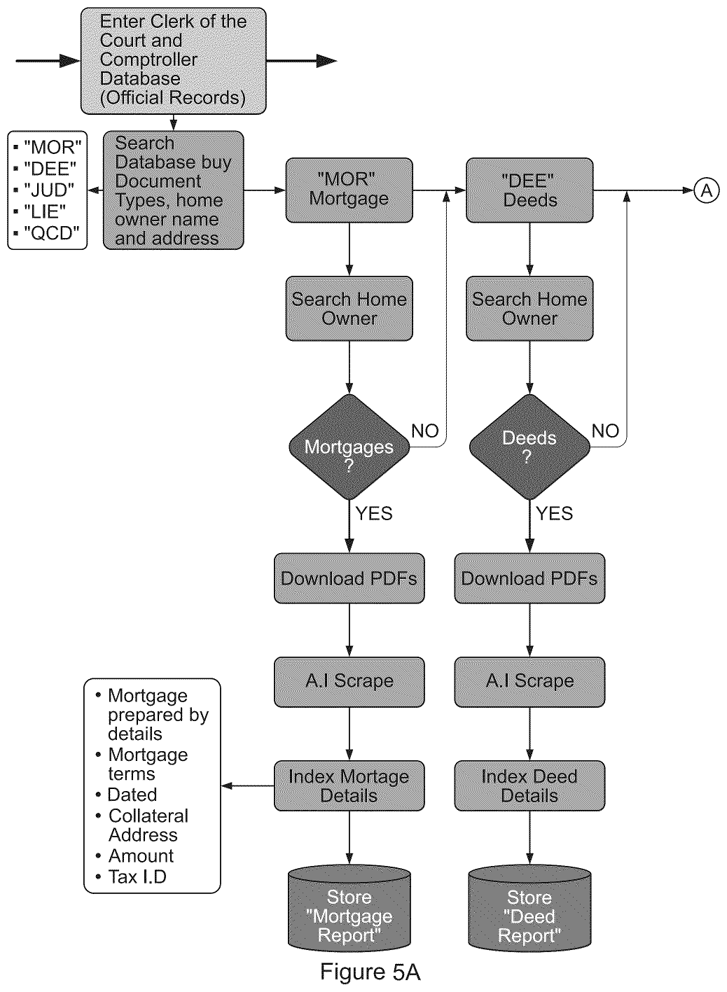

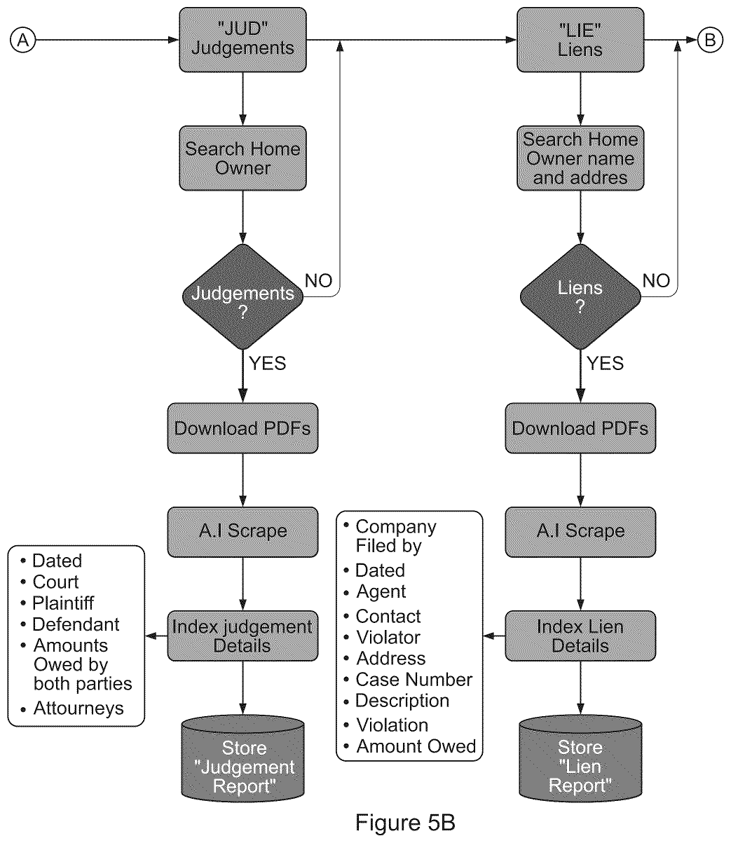

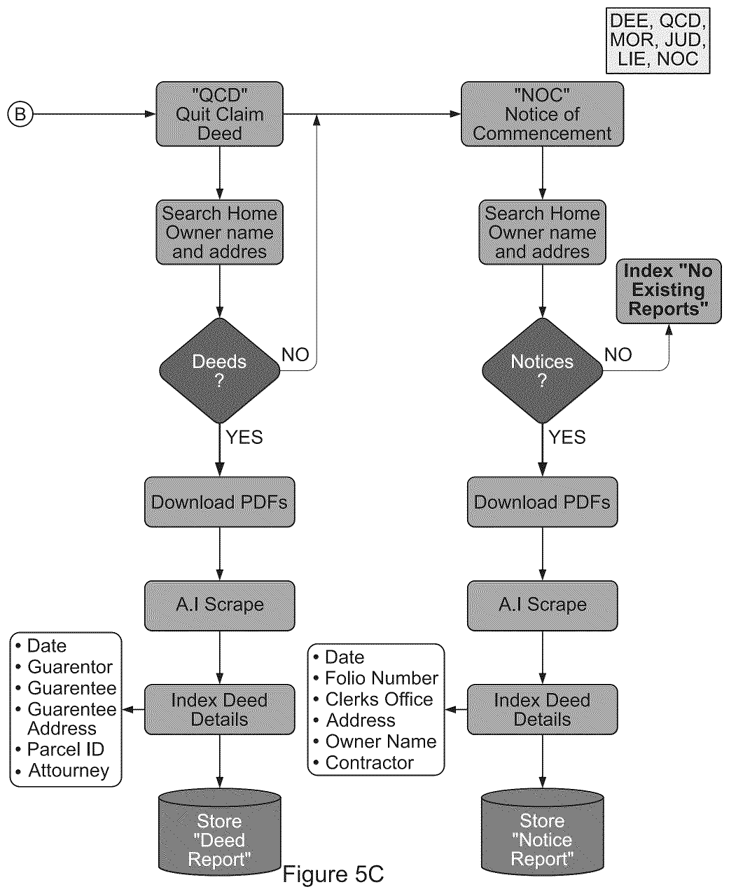

In the exemplary embodiment and as shown in FIGS. 2-6c, FIG. 2a-2c provides a flow process chart for the system 1. The system 1 will utilize a selected property through product decision. The system will begin to generate title monitoring and a rapid report. FIG. 2a depicts the moment a user selects their product. The first step in the title verification data flow is to go to the county Property Appraiser data source and search for the property. This search returns the Warranty Deed for the property as well as all of the information associated with a property (e.g. Owner Info, Property Info, Sales Info, etc.).

In the exemplary embodiment, to provide the rapid report, the system will enter a property appraiser site. The system 1 will access the site and perform a search of the selected property using either the home owner's name and address, once accessed the system 1 will access the warranty deed and scrape through A.I. Data scraping the Buyer, Seller, Transaction Date, Transaction, Amount and Filing Details this information will be sourced and indexed by chain of title. The indexed chain of title combined with the index folio number and index property information will be stored as a chain of title.

In the exemplary embodiment, the system 1 will then access the Clerk of the Court and Comptroller Database. The system will enter the municipality permit database if relevant and continue to enter databases as needed.

In the exemplary embodiment, the system will determine the databases need through the home address of the property.

In the exemplary embodiment, the system 1 will search municipal permits that are relevant to the property. The system will then determine if there are open permits, if there are open permits, the system will scrape the relevant information from the permit such as Permit Type, Date Issued, Date Applied, Expirations Date, District, Description, Fees, Paid/Remaining, Inspections. The system will then index and store the relevant permit information in the system 1.

In the exemplary embodiment, if the system 1 determines that there are no open permits, the system will conclude and store through the permit report “no existing permits”. Through the information access through the databases, a rapid report will be generated. Simultaneously, the system will continue to monitor the title of the property, if there is a change, the system will notify the interested user, if no change, the system will repeat the process in the 24 hour timeframe.

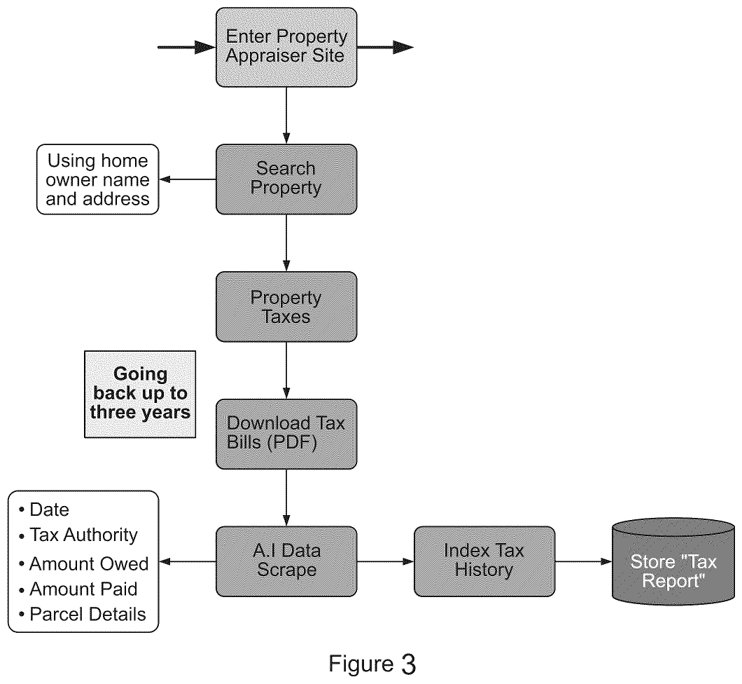

In the exemplary embodiment as shown in FIGS. 3-5c provides a flow process chart for the system 1 to gather relevant additional information for the relevant property.

In the exemplary embodiment, the system 1 will enter the property appraiser site and search for the selected property. The system 1 will access and download the property taxes. The system will then scape through A.I. data scraping the Date, Tax Authority, Amount Owed, Amount Paid and the Parcel Details. One skilled in the art would understand the applicant's design is not the exclusive embodiment. The system 1 will index and then store the tax report.

In the exemplary embodiment, the system 1 will enter the Clerk of the Court and Comptroller Database. The system 1 will access the search code enforcement's using the folio number of the relevant property. The system will determine whether a violation has occurred. If a violation occurred, the system will scrape through A.I. data scraping the Violator, the Address, the Code Section, the Description, the Issuing Department, the Date and the Inspector. The system will then index and store a code enforcement report. If the system determines no violations have occurred, the system 1 will index and note “no existing reports” and then store the information within the code enforcement report.

In the exemplary embodiment, the system 1 will enter the Clerk of the Court and Comptroller Database (Official Records) and search for relevant mortgages and deeds on the relevant property. If the system 1 determines there is a living mortgage or living deed on the relevant property, the system 1 will scrape the relevant information through A.I. Data scraping. The system 1 will extract from the mortgage relevant details such as, Mortgage terms, Dated, Collateral Address, Amount, Tax I.D. The system will index and store the information within the mortgage report. If the system determines there is a living deed with the relevant property, the system will index and store the deed in the deed report.

In the exemplary embodiment, the A.I. data scraping though out system is utilized to interpret OCR data and transform it into structured data.

In the exemplary embodiment, if the system determines there is no deed, the system 1 will search for judgements related to the relevant property. If a judgement is found, the system 1 will extract the Date, the Court, the Plaintiff, the Defendant, the Amounts Owed by both parties and Attorneys. The relevant information will be indexed and stored within the judgement report. If the system determines there are no judgments, the system will search for liens on the relevant property. If the system locates a lien, the system will extract information such as the Company who Filed the Lien, the Date, the Agent, the Contact, the Violator, the Address, the Case Number, the Description, the Violation, the Amount Owed. The system will index and then store the lien information in the lien report.

In the exemplary embodiment, if the system determines that there is no lien, the system will search for Quit Claim Deeds. If the system 1 determines there is a quit claim deed, the system will extract through the index deed, the Date, the Guarentor, the Guarantee, the Guarantee Address, the Parcel ID and the Attorney. The relevant information will be indexed and stored into a deed report. If the system determines that there are no quit claim deeds, the system will search notice of commencements for the relevant property.

In the exemplary embodiment, the system 1 will search for notices regarding the property, if the system locates a notice, the system 1 will extract the index deed details such as the Date, the Folio Number, the Clerks Office, the Address, the Owner Name and the contractor. The system will index and store the information in a notices report.

In the exemplary embodiment, if the system determines that there are no notices regarding the relevant property, the system will index “no existing reports”.

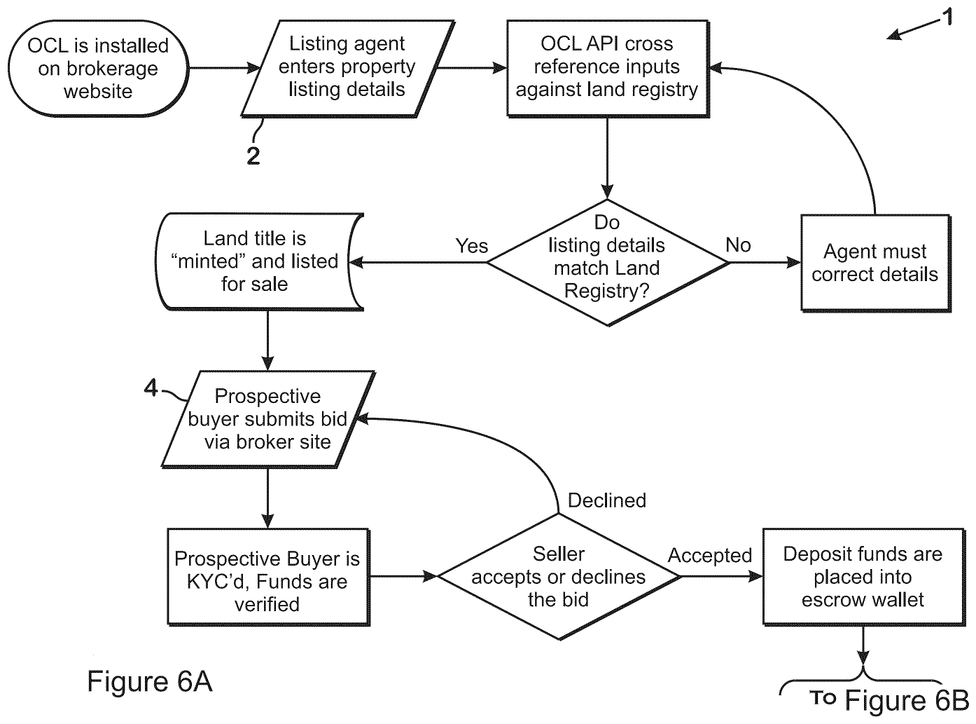

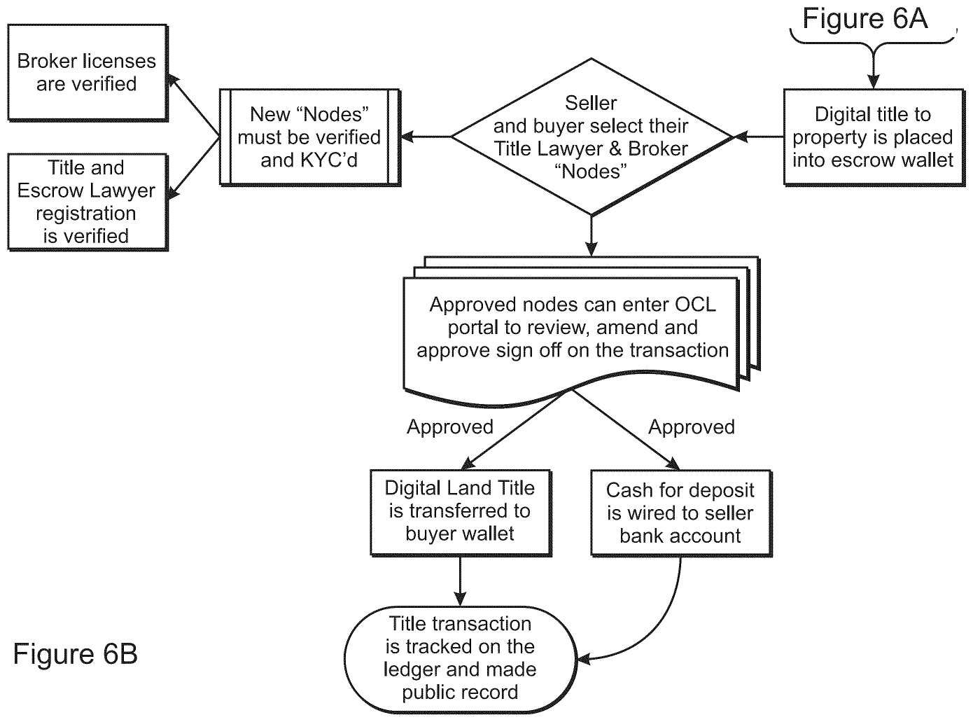

In the exemplary embodiment and as shown in FIG. 6a-6b are presented as diagrams to illustrate the interaction between the listing agent, the buyer, the seller, the title lawyer and broker.

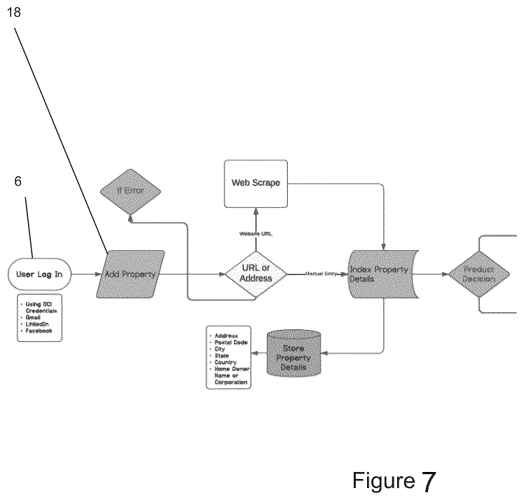

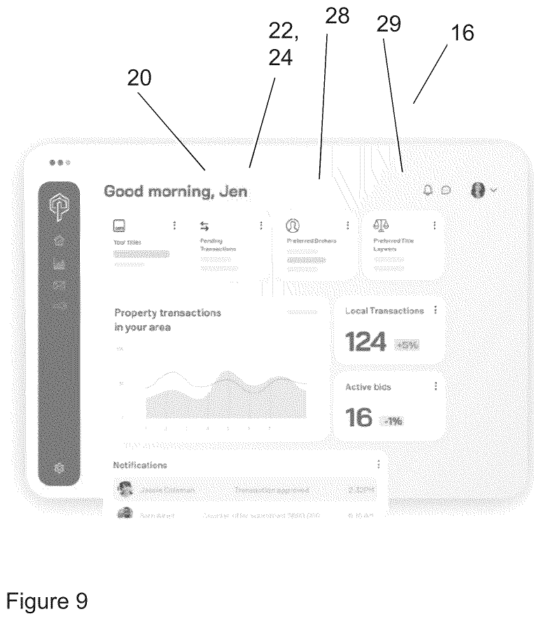

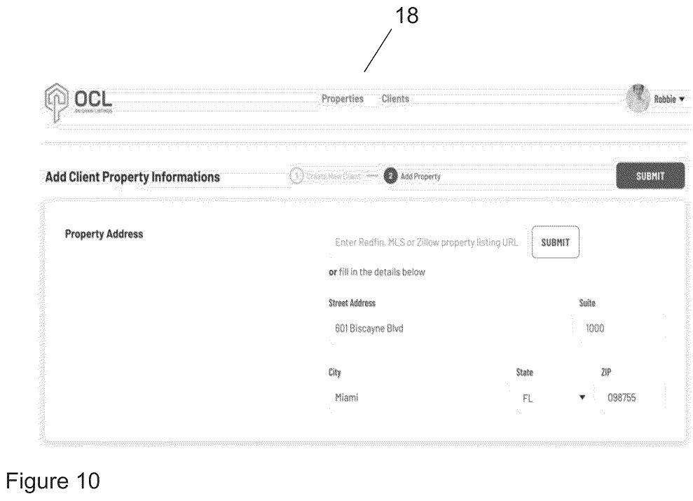

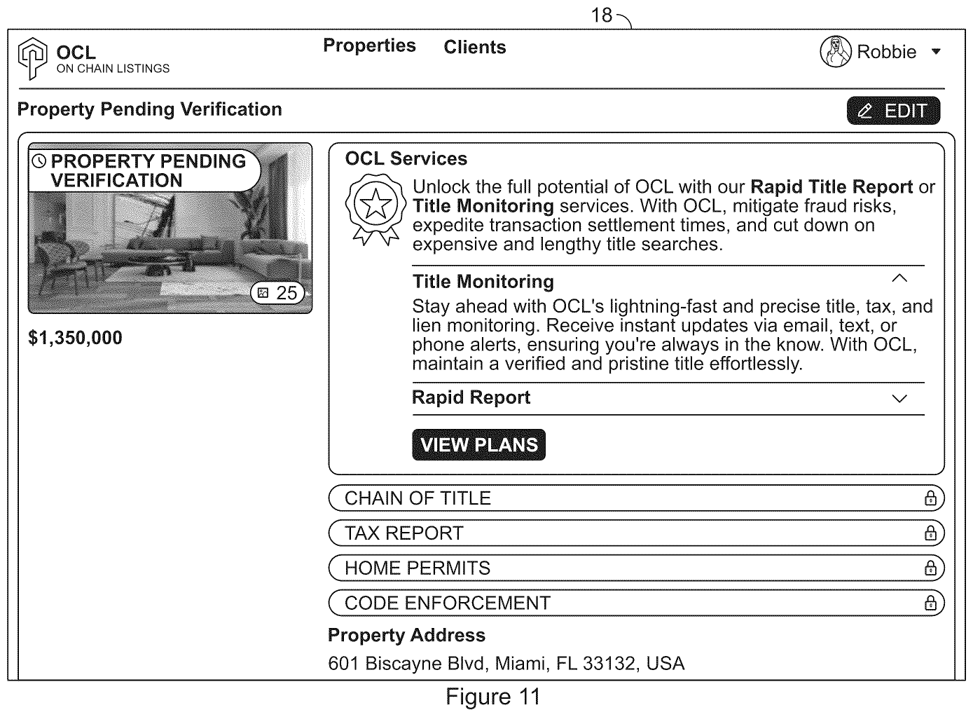

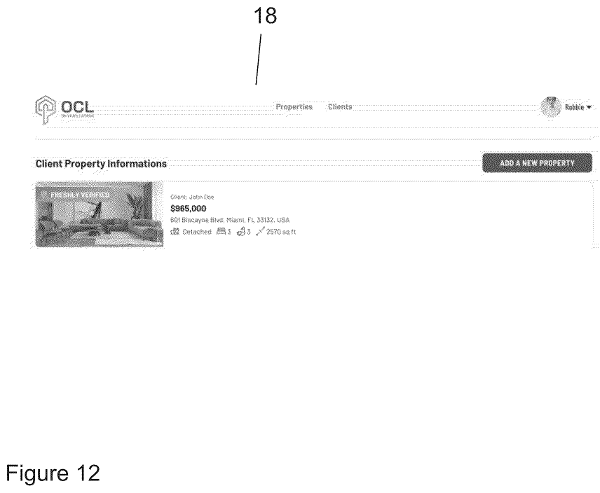

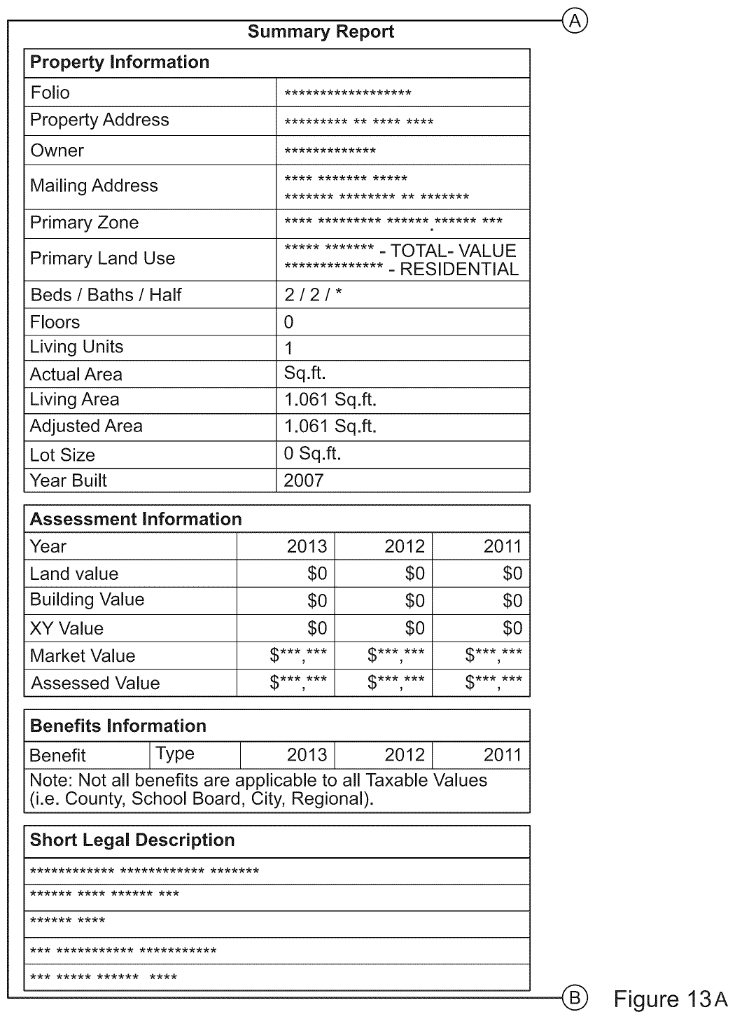

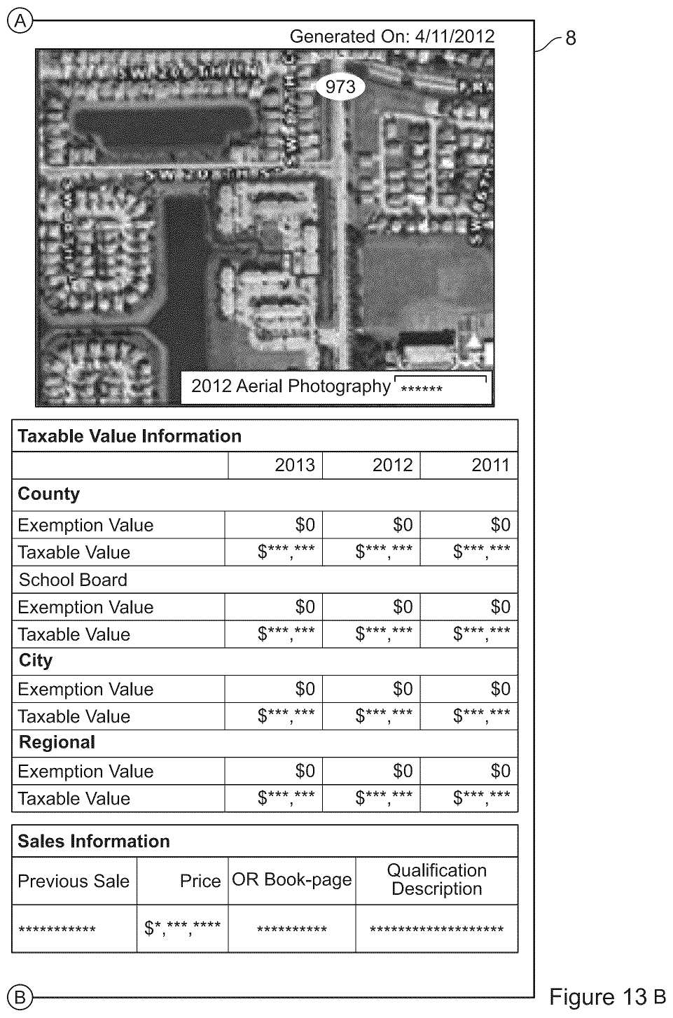

In the exemplary embodiment and as shown in FIGS. 7-17, is presented to illustrate the interactions of the property interactive system 1.

In the exemplary embodiment, the property interactive system 1 provides an exemplary set of templates and tools for use by the property seller 2 to identify and organize property listings such elements which may include copying, dating and digitizing files into coherent groupings for subsequent entry.

In the exemplary embodiment, the property interactive system 1 includes a plurality of property seller user functions. The plurality of property seller user functions includes a plurality of seller modules 12.

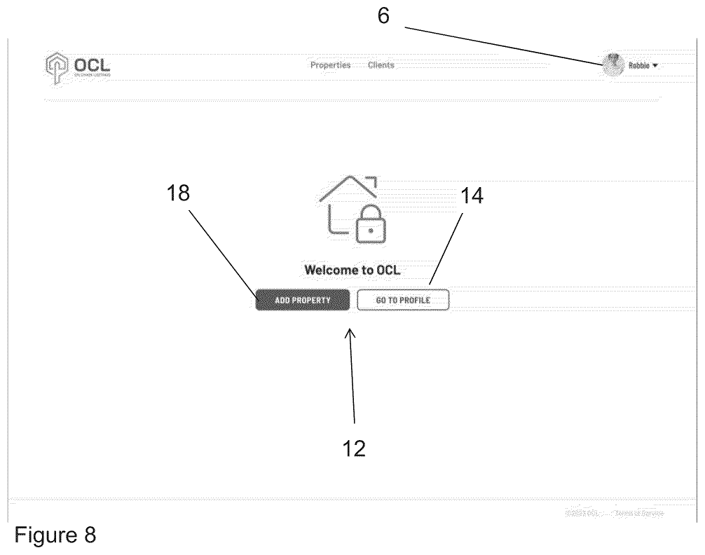

In the exemplary embodiment and as shown in FIG. 8, the property seller module 12 includes a property seller page module 14 accessible by a login 6 through either an independent web application or phone application. In another exemplary embodiment, the property seller page module 14 may be accessible through a known brokerage website. The property seller page module 14 is an icon represented on a main page 16 of a seller user's account. The property seller page module 14 permits the seller 2 to access the plurality of seller modules 12 on a seller main page 16.

The plurality of seller modules 12 include an add property module 18 and a review property module 20.

The add property module 18 provides the seller 2 the ability to input important information regarding the property the seller wishes to list for potential purchasers. For example, this information may include address, property characteristics, price, sales terms, tax information, and (in most cases) pictures. One skilled in the art would understand the applicant's design is not the exclusive embodiment.

In the exemplary embodiment, the review property module 20 provides the seller 2 to inspect pending buyer offers. The review property module 20 further includes an approve or deny buyer offer module. The approve buyer offer module 22 provides the seller to accept the offer. The deny buyer offer module 24 provides the seller to deny the offer. One skilled in the art would understand the applicant's design is not the exclusive embodiment.

The plurality of seller modules 12 further include a rapid report module 26 which will be described below.

In the exemplary embodiment, the plurality of seller modules 12 further includes an add real estate agent module 28.

In the exemplary embodiment, the plurality of seller modules 12 further includes an add title lawyer module 29.

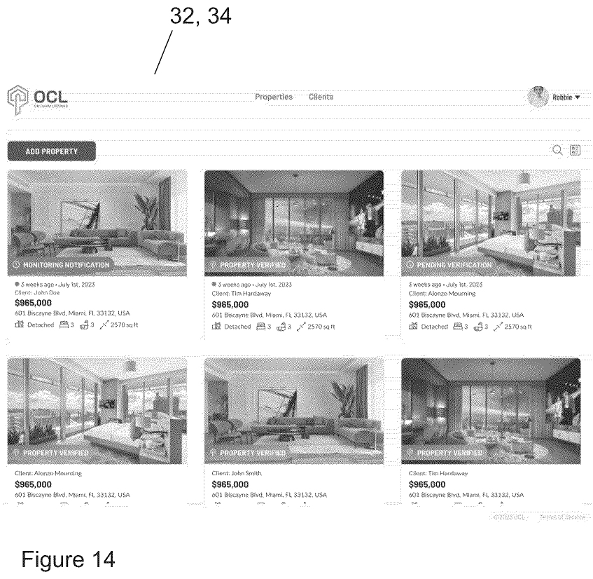

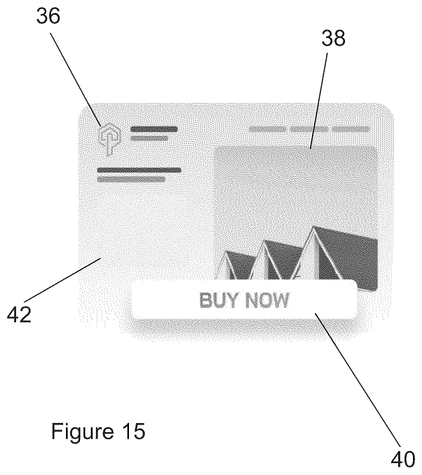

In the exemplary embodiment and as shown in FIGS. 14-15, the property interactive system 1 includes a plurality of buyer user functions. The buyer 4 using the property interactive system 1 includes plurality of property buyer user functions including a plurality of buyer modules 32.

The property buyer module 32 includes a property buyer page module 34 accessible by login similar to the property seller page module 14. The property buyer page module 34 is an icon represented on a main page 36 of a buyer user's account. The property buyer page module 34 permits the buyer 4 to access a plurality of buyer modules 32 on a buyer main page 36.

The plurality of buyer modules 32 includes a view property module 38 and a review pending offer module 42.

The view property module 38 provides the buyer 4 to view important information regarding the specific property provided by the seller 2. One skilled in the art would understand the applicant's design is not the exclusive embodiment. The view property module 38 further includes a buy now module 40 permitting a buyer 4 to enter an offer for the specific property.

The review property module 42 provides the buyer to review pending offers to the seller. The review property module 42 further provides indication if an offer is approved or denied by the seller.

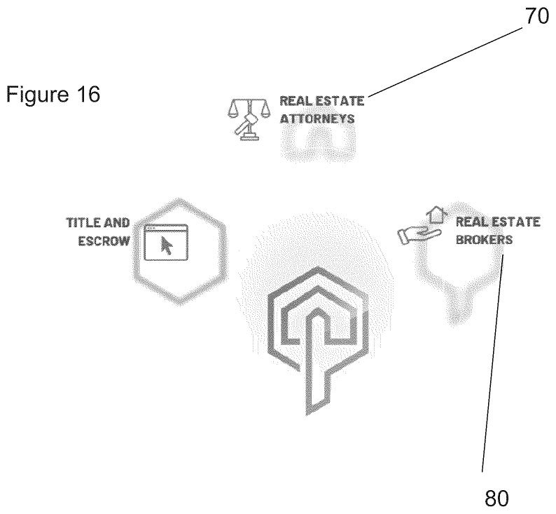

In the exemplary embodiment and as shown in FIG. 16, a title lawyer module 70 and a real estate agent module 80. The seller 2 will be permitted to choose a title lawyer and real estate agent through the add real estate module 28 and the add title lawyer module 29. The buyer is provided similar abilities.

In the exemplary embodiment, the chosen title lawyer and real estate agent will utilize the title lawyer module 70 and the real estate agent module 80 permitting the title lawyer and the real estate agent a multi-signatory system to authenticate, document, and verify property & title transfers on-chain in return for a processing fee, similar to a proof of work protocol. On-chain

In the exemplary embodiment and as shown in FIGS. 6a-16, the property interactive system 1 is presented and accessible through an independent web application or phone application.

In the exemplary embodiment, the property interactive system 1 will be activated by the property seller 2 entering the property information in the add property module 18. The property seller 2 may also simply input a URL from a known brokerage site where the property interactive system 1 communicates with the brokerage site. The property interactive system 1 takes the URL associated with the listing from the external site and uses the address, postal code, and listing details to source, verify, and document a complete title report 8. Essentially, the property interactive system 1 takes the listing URL, and extracts and indexes the address and listing details. Using the listing details, the property interactive system 1 runs a data scrape across various government and municipality databases to source and amalgamate the Rapid Report 26, this includes data such as: Chain of Title, Tax Filings Code Violations, Permits, Mortgages, Liens Quit Claim Deeds, Judgements, Notice of Commencement etc. One skilled in the art would understand the applicant's design is not the exclusive embodiment.

Additionally, the property interactive system 1 provides a title monitoring module 50. With this module, the property interactive system 1 conducts daily searches and promptly notifies homeowners of any changes to the title search via text, email, and phone calls. This ongoing monitoring ensures timely awareness of any modifications to the title, encompassing both new and existing filings spanning the last 20 years. These searches occur every 24 hours and only provides feedback notification if a change has occurred to the property filings of the seller 2.

The property interactive system 1 communicates with a plurality databases using A.I operated data scraping that searches the PDF documents and webpages for specific details associated with each report. This includes information such as: Names, Dates, Details on the parties who filed, Addresses, Tax ID Numbers, Emails, Phone Numbers, Dollar values for amounts owed, Interest Rates, Violations, Descriptions, Hearing dates, Attorney name, firm, and contact details Clerks office. One skilled in the art would understand the applicant's design is not the exclusive embodiment.

In the exemplary embodiment, and as noted above, the property interactive system 1 will run a cross reference of the information in the add property module 18 with a land registry module by accessing various public sources, depending on the jurisdiction, typically available through online databases containing scanned PDF documents. Sources such as the County Clerk of the Court and Comptroller, Property Appraiser Site, and County Clerk Code Enforcement are utilized through publicly accessible websites and scraped through data scraping. One skilled in the art would understand the sources utilized by the property interactive system 1 are not the exclusive embodiment.

Upon receiving a verified KYC'd customer's property address, the property interactive system 1 retrieves a chain of title directly from the Appraiser Database, facilitating the download of PDF reports for the Chain of Title and Warranty Deeds. Subsequently, the property interactive system 1 employs artificial intelligence and algorithms to extract pertinent information such as the homeowner's details, address, folio number, and transaction date from the Warranty Deed. Leveraging the obtained folio number, the property interactive system 1 conducts comprehensive searches encompassing property liens, codes, permits, additional homeowners, and mortgages. This allows the property interactive system 1 the verification of personal liens, court rulings, utility liens, quit claim deeds, and more, all associated with the verified homeowner's name present on the Warranty Deed. In instances where the property owner is a corporation, the property interactive system 1 further identifies and lists the shareholders of the entity within the title report.

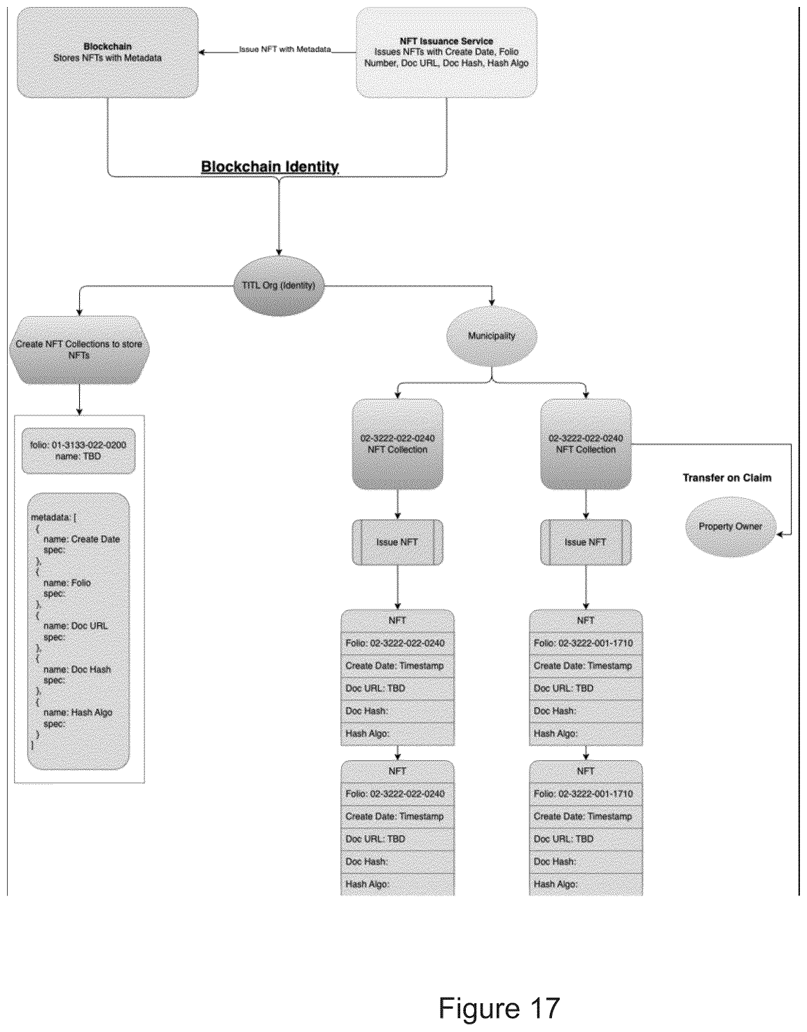

In the exemplary embodiment and with reference to FIG. 17 which depicts the flow and process the system implements for issuing an NFT on the Polymesh blockchain. When a report is generated in the system, a command is issued to the NFT Issuance Service to issue an NFT for the property with the provided NFT Metadata. The information provided to the NFT Issuance Service is used to locate the correct NFT Collection the NFT belongs to and will be issued on.

In the exemplary embodiment, when the property interactive system 1 verifies the inputs of the add property module 18, a title to the property will be “minted” onto the blockchain as an asset via a blockchain-based smart contract. The property interactive system 1 mints by converting the verified property title data into a format suitable for blockchain storage. Specialized algorithms and protocols are utilized to ensure the integrity and security of the data during the minting process. The reports are generated and minted as nfts on the blockchain are hashed using the sha256 algorithm in order to ensure data integrity and included as metadata associated with the nft during the minting process. Nft collections are created based on the property's folio number in order to categorize the land registry on chain effectively, and the nfts reside in their respective collections. The document itself is also stored in cloud storage. The URL reference to the document is also stored as metadata associated with the nft during the minting process. Nfts issued on a Polymesh blockchain are created in compliance with the Polymesh blockchain security token framework. Nfts on the Polymesh blockchain can only be issued as part of an NFT Collection and must include specific metadata defined by the NFT Collection in order to be considered a compliant NFT for the NFT Collection.

Once minted, the asset becomes permanently recorded on the blockchain, providing users with secure and transparent access to their property deeds.

In the exemplary embodiment, the property seller 2 can interact with the smart contracts through the system's platform, accessing their property title data securely using designated wallet addresses and private keys. The system provides user-friendly tools and resources for managing and verifying property deeds. Once the data has been verified and minted, the property seller 2, in addition to their “Agents” who are designated by the homeowner/seller will be allocated private keys to gain access to view the data.

In the exemplary embodiment, the blockchain-based smart contract creates an official digital copy of the land registry record and publishes the property for viewing by the property buyer 4. The blockchain implementation is embedded with smart contracts in the base layer of the blockchain that facilitates the minting of nfts via api command. The multi-signature required for transfer will enable verified parties who have been both vetted by the homeowner and the KYC process to sign off on the editing or transfer of a property title.

In the exemplary embodiment, property buyers 4 will view the property on the view property module 38 by permitting the buyer 4 to log into a web-based brokerage site where they will be able to view listings that have been made available by the brokerage/seller. The property interactive system 1 will provide the buyer the availability for immediate purchase using an on-chain title and will show a “Buy Now” on the buy now module 40 of the view property module 38.

On-chain title may refer to the NFT that is generated as the result of the report generation process. The NFT includes the following metadata to uniquely identify an “on-chain title”: 1.Create date: timestamp indicating when the nft was issued. 2. Property Identifier: Indicates the unique identifier assigned by the county for the property (folio number). 3. Storage Key: Indicates the file location in the Cloud storage where the generated Report is located. 4. Document Hash: An MD5 hash of the Document Contents. 5. Hash Algorithm: The hashing algorithm used to hash the document (MD5). One skilled in the art would understand the applicant's design is not the exclusive embodiment.

Once the buyer selects “Buy Now,” on the buy now module 40, the buyer will be prompted by a verification portal.

In the exemplary embodiment, the verification portal will require a full Know Your Customer (“KYC”) to be conducted in order to meet the standards of the local municipality of the property. The property interactive system 1 will verify the buyer as a KYC to the local municipality per municipal rules.

In the exemplary embodiment, the buyer 4 will be considered a “verified buyer”, once verified. The buyer 4 will proceed and submit their bid price, a deposit amount, financing details to be verified with a financial institution, and any closing terms the buyer wishes to make the bid contingent. One skilled in the art would understand the applicant's design is not the exclusive embodiment.

In the exemplary embodiment, the now verified buyer 4 will have the option to select their preferred title lawyer and real estate agent by adding a title lawyer and a real estate agent similar to what is utilized by the seller 2 in the add real estate agent module 28 and the add title lawyer module 29. The add real estate agent module 28 and the add title lawyer module 29 for both the seller 2 and the buyer 4 will include an approved list of individuals that are verified in the appropriate jurisdiction.

The buyer 4 will provide the chosen title lawyer and real estate agent access to the property interactive system if the chosen title lawyer and the real estate is already an approved agent by the property interactive system 1. One skilled in the art would understand the applicant's design is not the exclusive embodiment.

If the buyer 4 chooses to use a title lawyer and real estate agent that are not an approved agent, the property interactive system 1 will verify the license and registration of the title lawyer and the real estate agent through the appropriate channels of the respective associations.

In the exemplary embodiment, in order to be approved as an approved agent, real estate agents and lawyers will need to pass a KYC in addition to proving their registration status, to prove that they are currently regulated in the appropriate jurisdiction. Once approved, the approved title lawyer and the approved real estate agent will now have the ability to sign off on the transaction. The approved agent will access a portal to review and sign off on the title report, access to a portal to review and sign off on the purchase and sale agreement and access to a portal to review and sign off on the closing disclosure.

In the exemplary embodiment, the seller 2 will receive a notification of a proposed bid. The seller 2 will proceed to the property seller page module 14. The seller 2 will access the review property module 20 to inspect pending buyer offers.

The seller 2 will be able to accept or decline the proposed bid by the approved buyer offer module 22 and the deny buyer offer module 24.

In the exemplary embodiment, if the bid is accepted by the seller 2 then a notification will be sent to the approved title lawyer and the approved real estate agent for signatures.

Simultaneously, the digital title to the property and the deposit amount are held in an escrow wallet until all approvals are completed.

In the exemplary embodiment, the title lawyer module 70 and the real estate agent module 80 will enable and permit the title lawyer and the real estate agent a multi-signatory system to authenticate, document, and verify property & title transfers on-chain in return for a processing fee, similar to a proof of work protocol.

In the exemplary embodiment, with the sign-offs having been completed by all the parties approved agents, the title is now able to be exchanged for the deposit amount. Here, the digital title to the property will be sent to the buyer's native wallet which will be accessible via the property interactive system 1, revealing all the property details and ownership history. Simultaneously, the capital for the deposit amount will be wired over to the selling party i.e. seller 2.

The above description is only for the specific embodiment of the present invention and is not intended to limit the scope of the present invention. The equivalent changes or modifications made by the structures, features and principles of the present invention should be included in Within the scope of the patent application of the present invention.

What is claimed is:

1. A property interactive system, comprising:
a selectable property by a front-end user within a front-end user functionality triggering a plurality of back-end user functionalities; the plurality of back-end user functionalities generate a title monitoring module and generate a rapid report module; the back-end user functionality will access a property appraiser site and perform A.I. data scraping of a buyer, seller, transaction date, transaction and amount which is indexed by a chain of title through an index folio number and an index property information; the plurality of back-end user functionalities will access appropriate municipal records and determine if there are open permits on the selectable property and perform A.I. data scraping of a permit type, a date issued, a date applied, an expirations date, a district, a description and index and store information within the chain of title and formulate the generated rapid report, and send the generated rapid report to the front-end user, the back-end user functionality will repeat the process in a repeated daily timeframe.

2. The property interactive system of claim 1, wherein the system further enters the property appraiser site and retrieves relevant property taxes for the selectable property and A.I. data scrapes a date, a tax authority, an amount owed, an amount paid and parcel details.

3. The property interactive system of claim 2, wherein the system further enters a clerk of a court and comptroller database and access a search code enforcement using the folio number of the selectable property.

4. The property interactive system of claim 3, wherein the system determines whether a violation has occurred and A.I. data scrapes relevant information including a name of violator, an address of the violator, a code section, a description, an issuing department, a date and an inspector and stores a code of enforcement report in the index within the chain of title.

5. The property interactive system of claim 4, wherein the system enters the clerk of the court and comptroller database and accesses relevant mortgages and deeds of the relevant property and A.I. data scrapes relevant details such as a mortgage term, a date, a collateral address, an amount, a tax I.D and stores information in the index within the chain of title.

6. The property interactive system of claim 5, wherein the system will search for relevant judgements when no deed is located within the database.

7. The property interactive system of claim 6, wherein the system locates judgement and A.I. data scrapes a date, a court, a plaintiff, a defendant, an amount owed by parties and stores a judgment report in the index within the chain of title.

8. The property interactive system of claim 7, wherein the system will search for liens on the selectable property when no judgement is located within the database.

9. The property interactive system of claim 8, wherein the system locates a lien and A.I. data scrapes a company who filed the lien, a date, an agent, a contact, a violator, an address, a case number, a description, a violation, an amount owed and stores a lien report in the index within the chain of title.

10. The property interactive system of claim 9, wherein the system will search for quit claim deeds on the selectable property within the database.

11. The property interactive system of claim 10, wherein the system will locate a quit claim deed and A.I. data scrape a date, a guarentor, a guarantee, a guarantee address, a parcel I.D and store relevant information in a quit claim deed report in the index within the chain of title.

12. The property interactive system of claim 11, wherein the system will search for notices regarding the selectable property.

13. The property interactive system of claim 12, wherein the system will locate a notice and A.I. data scrape a date, a folio number, a clerks office, an address, an owner name and a contractor and store relevant information in a notices report in the index within the chain of title.
